(19) United States
(12) Patent Application Publication
(10) Pub. No.: US 2020/0264823 A1
(43) Pub. Date: Aug. 20, 2020

(54) DISPLAYS

(71) Applicant: Hewlett-Packard Development Company, L.P., Spring, TX (US)

(72) Inventors: John W. Frederick, Spring, TX (US); Humberto M. Fossati, Spring, TX (US); Tim Guynes, Spring, TX (US); Wen Shih Chen, Taipei City (TW)

(73) Assignee: Hewlett-Packard Development Company, L.P., Spring, TX (US)

(21) Appl. No.: 16/649,160

(22) PCT Filed: Nov. 7, 2017
(86) PCT No.: PCT/US2017/060420

§ 371 Date: Mar. 20, 2020

(51) Int. Cl. G06F 3/147; G06F 9/451; G06K 19/06; G09G 5/377; G06F 3/0482

(52) U.S. Cl. CPC G06F 3/147; G06F 9/451; G06K 19/06028; G06K 19/06037; G09G 2340/12; G06F 3/0482; G09G 2354/00; G09G 2380/04; G09G 5/377

(57) ABSTRACT

A display includes a memory including electronic rating label information and a scaler to display the electronic rating label information from the memory on the display.

### BACKGROUND

Various countries statutorily impose labeling requirements on sellers of consumer electronic devices. For instance, the Federal Communications Commission (FCC) of the United States imposes, under Title 47. Code of Federal Regulations (C.F.R.) Part 15, rules and regulations regarding unlicensed transmissions. As many electronic devices sold in the United States can be classified as an emitter or radiator, these electronic devices must be certified and must bear an FCC Declaration of Conformity and Certification (DoC) certification mark on the product label. Similarly, other countries impose their own standards on certification and labeling of electronic devices classified as an emitter or radiator (e.g., the Certification and Accreditation Administration of the People's Republic of China (CCC) certification mark for China or the VCCI (Voluntary Council for Control of Interference) mark for Japan, etc.).

The physical labels are affixed to the electronic device and include the certification mark together with information such as the trade name for the device, manufacturer-specific identifiers and device-specific information (e.g., electronic device model number, electronic device serial number, identifying information for an emitter used in the electronic device, etc.).

### BRIEF DESCRIPTION OF THE DRAWINGS

FIG. 1 represents a display having a physical label bearing rating information affixed to a rear of the display.

FIG. 2 is a schematic illustration of an example display and an example display controller in accordance with the teachings of this disclosure.

FIG. 3A is an illustration of an example menu layer implemented by the example display controller of FIG. 2 in accordance with the teachings of this disclosure.

FIG. 3B is an illustration of an example first display of electronic rating label information presented by the example display controller of FIG. 2 in accordance with the teachings of this disclosure.

FIG. 3C is an illustration of an example second display of electronic rating label information presented by the example display controller of FIG. 2 in accordance with the teachings of this disclosure.

FIG. 4 depicts an example use case for an example electronic rating label in accordance with the teachings of this disclosure.

FIGS. 5A-5B are flowcharts representative of machine readable instructions that may be executed to implement the example display controller of FIG. 2.

FIG. 6 is a flowchart representative of a method that may be implemented to update the example display controller of FIG. 2.

FIG. 7 is a processor platform to execute the instructions of FIGS. 5A-5B to implement the example display controller of FIG. 2.

The figures are not to scale. Wherever possible, the same reference numbers will be used throughout the drawing(s) and accompanying written description to refer to the same or like parts. While the drawings illustrate examples of printers and associated build controllers, other examples may be employed to implement the examples disclosed herein.

### DETAILED DESCRIPTION

The examples disclosed herein relate to systems and methods for using an example display controller to implement an electronic rating label. The example electronic rating label disclosed herein is a substitute for physical rating labels, which may present challenges to positioning and legibility.

In some examples, a display includes a memory including information of a menu layer and electronic rating label information and a scaler to overlay the menu layer over a source video image using the memory, the menu layer including a first option to display the electronic rating label information and a second option to display an adjustment interface. For instance, the example display controller supports an on-screen display (OSD) menu layer including selectable elements or options including a selectable element or option to display the electronic rating label or to display electronic rating label information on the display device.

In some examples, a method includes retrieving a menu layer from a display device memory in response to activation of a button on the display device, retrieving electronic rating label information from the display device memory in response to selection of a selectable element corresponding to the electronic rating label information from the menu layer displayed on the display device and displaying the electronic rating label information on the display device.

The implementation of an electronic rating label enables the display of an electronic rating label that may be larger, and more legible, than a printed rating label, thereby enhancing legibility.

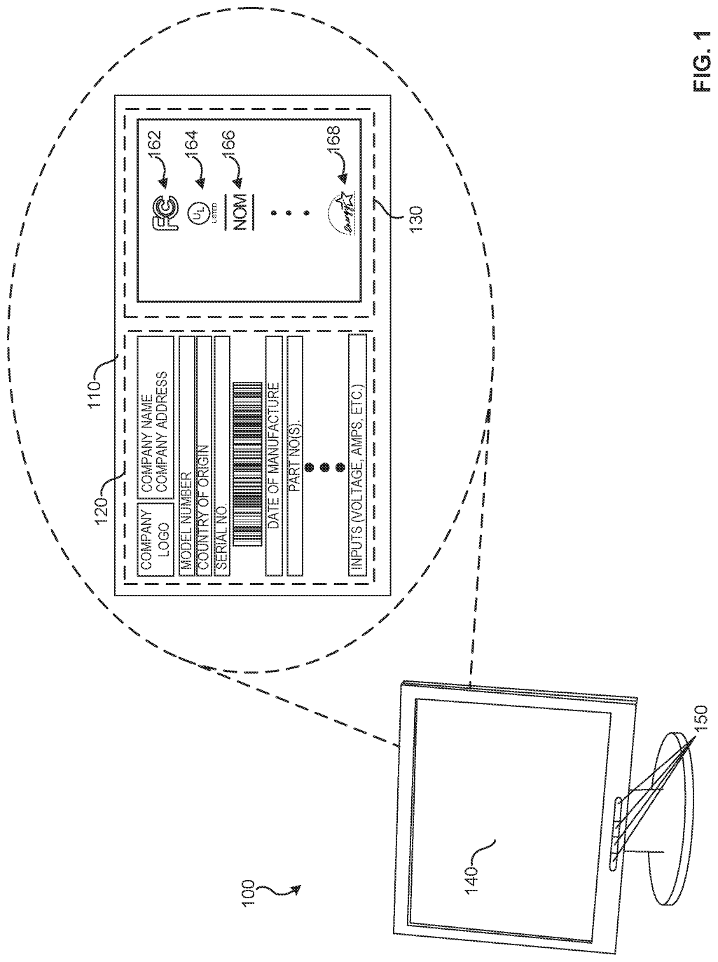

FIG. 1 shows a display device 100 having a physical label 110 bearing device information 120 and rating information 130 affixed to a rear of the display device 100. The display device 100 includes a screen 140 to display information to a user of the display device 100. The display device also includes pushbuttons 150, each corresponding to a predetermined function (e.g., power on/off, on screen display (OSD) navigation, etc.). In some examples, the pushbuttons 150 may include an auto adjust button to adjust the display device 100 to an ideal setting when the OSD is not active, a volume button and/or a menu button to open, select, or exit an OSD menu. The pushbuttons 150 may include a source pushbutton to choose a video input source from an attached computer, a first navigation pushbutton to navigate in a first direction through the OSD menu and to decrease an adjustment level of a value of a selected selectable element in the OSD menu and/or a second navigation pushbutton to navigate in a second direction through the OSD menu and to increase an adjustment level of a value of a selected selectable element in the OSD menu. The pushbuttons 150 may include an “Enter” or “OK” pushbutton to register an input.

The device information 120 portion of the physical label 110 includes information such as, but not limited to, a company logo, a company name, a company address, a model name, a model number, a device description, a country of origin, a serial number, a bar code, a date of manufacture, part number(s) and inputs (e.g., voltage, frequency, amps, etc.).

The rating information 130 portion of the physical label 110 includes information such as, but not limited to, certifications of government entities and/or non-governmental entities for jurisdictions in which the device (e.g., the display device 100) is manufactured, sold or used. For instance, the rating information 130 may include a Federal Communications Commission (FCC) declaration of conformity 162, Underwriters Laboratories (UL) certification mark(s) 164, a Norma Official Mexicana (NOM) mark 166 for electrical products imported into Mexico, or an ENERGY STAR mark 168 from the U.S. Environmental Protection Agency. The rating information 130 may include marks from more than one country and may include, for example, a Verband der Elektrotechnik, Elektronik and Informationstechnik (VDE) mark (Germany), a GS-Mark (Germany), an “emc-Mark,” a European EMC Mark, a Canadian Standards Association (CSA) mark, a D-Mark (Denmark), an electromagnetic compatibility (EMC) Mark, a Fimko Fl Mark (Finland), a Fimko EMC certificate, the Conformité Européene (CE) mark representing that the device comports with all relevant CE-marking Directives of European (EU) authorities and/or the China Compulsory Certification (CCC) Mark.

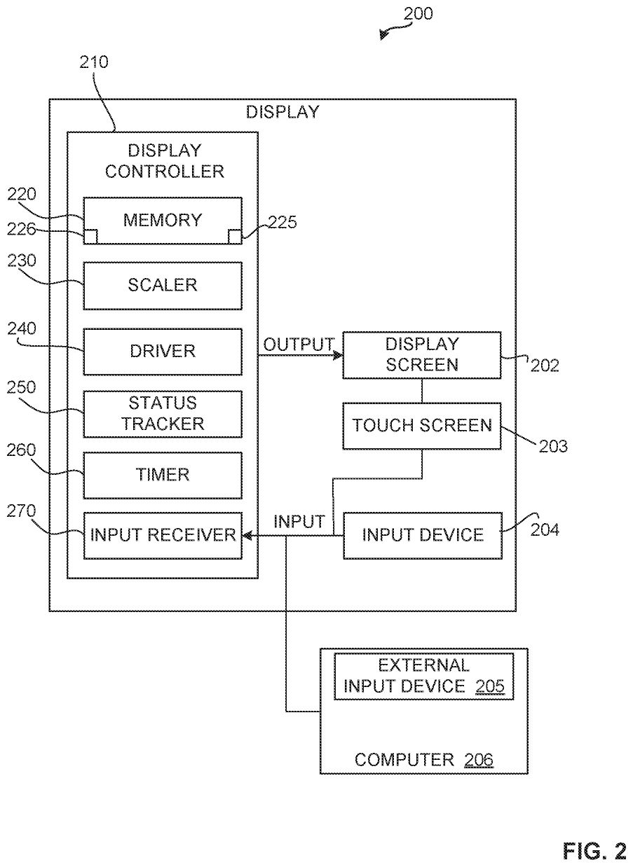

FIG. 2 illustrates an example implementation of an example display device 200, an example display screen 202, which may include an example touch screen 203, and an example input device 204. As shown in the example of FIG. 2, the display device 200 includes an example display controller 210 having an example memory 220 including electronic rating label information 225 corresponding to an electronic rating label and menu layer information 226 corresponding to a menu layer, an example scaler 230, an example driver 240, an example status tracker 250, an example timer 260, and an example input receiver 270. In some examples, the example memory 220 includes an example memory buffer.

The display device 200 and corresponding display screen 202 may include any display device including, but not limited to, a cathode ray tube display (CRT), a light-emitting diode display (LED), an electroluminescent display (ELD), an electronic paper or E-Ink display, a plasma display panel (PDP), a liquid crystal display (LCD), a high-performance addressing display (HPA), a thin-film transistor display (TFT), an organic light-emitting diode display (OLED), a surface-conduction electron-emitter display (SED), a field emission display (FED), or a digital microshutter display (DMS). The display device 200 may include a 2D or a 3D display that the display screen 202 of the display device 200 may include a touch screen 203.

In some examples, the input device 204 includes a pushbutton, or a plurality of pushbuttons, or the like (e.g., soft key, touch key, pushbutton panel, etc.) arranged on a display device 200 housing. For example, the input device 204 may include a set of front-panel controls for the display device 200, with a plurality of pushbuttons, each to execute at least one function. Example functions that may be performed by the input device 204 include, but are not limited to, activation or deactivation of a display device 200 mode (on/off/sleep, etc.), activation or deactivation of an on-screen display (OSD), increase/decrease in volume level of speakers, change in video input source, OSD navigation, auto adjust of the display device 200, and registering of a selection in the OSD (e.g., an “ENTER” pushbutton or “OK” pushbutton).

In some examples, the external input device 205 includes machine readable instructions in an external system, such as a computer 206, to provide feedback to the display controller 210 as to at least one aspect of operation of the display device 200 and/or sensor(s) relative to a system in which the display device 200 operates.

The display controller 210 is to generate a video signal for display on the display screen 202 of the display device 200. The display controller 210 is to, for example, generate a timing of the video signals, generate a blanking interval signal and manipulate video RAM contents. The display controller 210 is to support interfaces such as, but not limited to, Video Graphics Array (VGA), Digital Visual Interface (DVI), HDMI (High-Definition Multimedia Interface), DisplayPort, very-high-density cable interconnect (VHDCI), DMS-59 (Dual Monitor Solution, 59 pins), physical layer (PHY) low-voltage differential signaling (LVDS), PHY transition-minimized differential signaling (TMDS), PHY flat panel display (FPD) link, OpenLDI, and/or current mode logic (CML).

The memory 220 or frame buffer is to retain data sent to or received from the display controller 210. In some examples, the memory 220 includes a plurality of frame portions of menu layer information 226 and/or a frame portions of electronic rating label information 225. In some examples, the frame portions may include lines of menu layer information 226 and/or lines of the electronic rating label information 225. In some examples, the frame portions may include pixels of menu layer information 226 and/or pixels of the electronic rating label information 225. In some examples, the memory 220 includes a frame or frames of menu layer information 226 and/or a frame or frames of the electronic rating label information 225.

In some examples, the scaler 230, via the memory 220, is to enhance video output functionality, upscaling and downscaling the source video signal to the display screen's 202 native refresh rate or native resolution. In some examples, the scaler 230 is to modify a refresh input signal (e.g., 70 Hz to 60 Hz) to avoid a loss of video in the displayed image.

In some examples, the driver 240 is to interface a processor to the display device 200, to accept commands and data from the processor and to output signals to the display device 200 (e.g., signals having an appropriate voltage, current, timing, etc.) to enable the display device 200 to display the desired content.

In some examples, the status tracker 250 is to track performance-related metrics for the display device 200. For instance, in some examples, the status tracker 250 tracks a time, via the timer 260. The timer 260 is to track, for example, a cumulative number of hours of operation of the display device 200 or a time at which a particular condition or fault code is activated.

The example input receiver 270 is to receive inputs from the input device 204 and pass the inputs to the display controller 210, the memory 220, the scaler 230, the driver 240, the status tracker 250 and/or the timer 260.

While an example manner of implementing the display controller 210 of FIG. 1 is illustrated in FIG. 2, any one of the elements, processes and/or devices illustrated in FIG. 2 may be combined, divided, re-arranged, omitted, eliminated and/or implemented in any other way. In some examples, the memory 220, the scaler 230, the driver 240, the status tracker 250, the timer 260 and/or the input receiver 270 and/or more generally, the example display controller 210 of FIG. 1, may be implemented by hardware, software, firmware and/or any combination of hardware, software and/or firmware. Thus, for example, any of the memory 220, the scaler 230, the driver 240, the status tracker 250, the timer 260 and/or the input receiver 270 and/or more generally, the example display controller 210 of FIG. 1, could be implemented by an analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the memory 220, the scaler 230, the driver 240, the status tracker 250, the timer 260 and/or the input receiver 270 and/or more generally, the example display controller 210 of FIG. 1, is/are hereby expressly defined to include a tangible computer readable storage device or storage disk such as a memory, a digital versatile disk (DVD), a compact disk (CD), a Blu-ray disk, etc. storing the software and/or firmware. Further still, the example display controller 210 of FIG. 2 may include an element(s), process(es) and/or devices in addition to, or instead of, those illustrated in FIG. 2, and/or may include more than one of any or all of the illustrated elements, processes and devices.

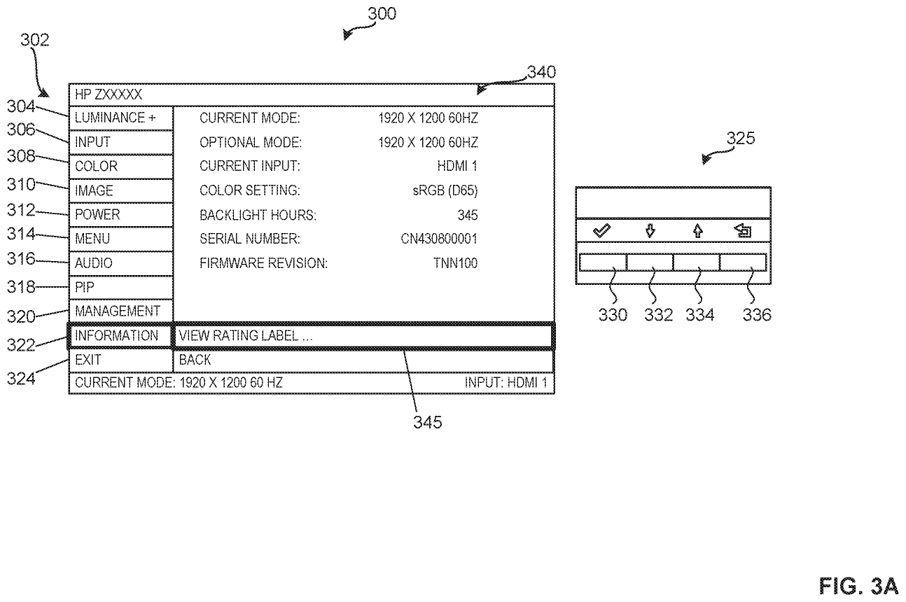

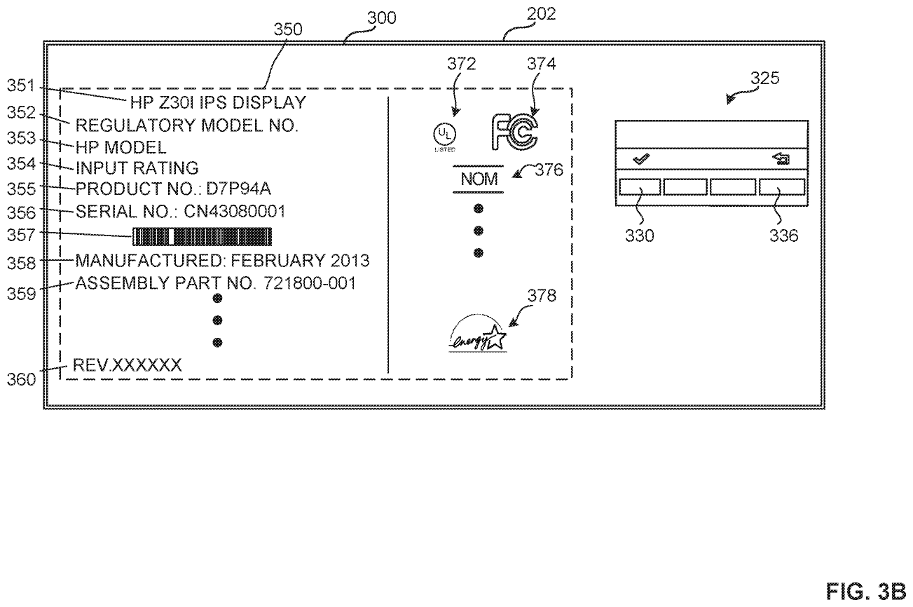

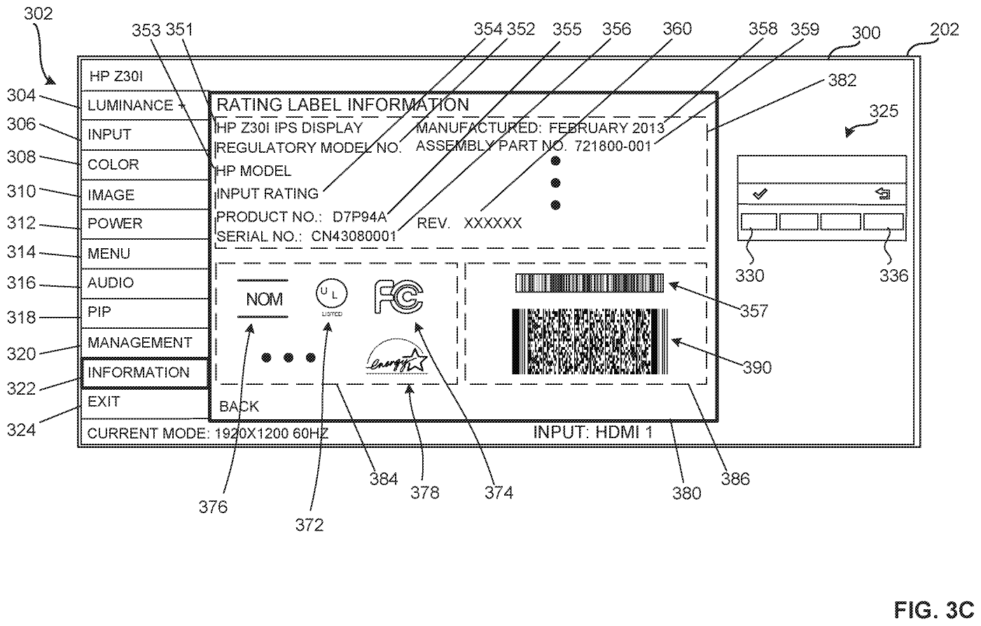

FIG. 3A is an illustration of an example menu layer 300, comprising the menu layer information 226, implemented by the example display controller 210 of FIG. 2. The menu layer 300 includes example selectable elements 302. In the illustrated example of FIG. 3A, the selectable elements 302 includes selectable elements for “LUMINANCE” 304, “INPUT” 306, “COLOR” 308, “IMAGE” 310, “POWER” 312, “MENU” 314, “AUDIO” 316, “PICTURE IN PICTURE (PIP)” 318, “MANAGEMENT” 320, “INFORMATION” 322, and “EXIT” 324. These selectable elements 302 are selectable via an example navigation interface 325 displayed in the menu layer 300 and/or via the input device 204 (e.g., pushbuttons, etc.) and/or via the external input device 205 (e.g., Bluetooth connected device, etc.). The example navigation interface 325 includes an example “ENTER” button 330, an example “DOWN” navigation button 332, an example “UP” navigation button 334, and an example “BACK” button 336. For example, the “DOWN” navigation button 332 enables navigation from a first selectable element 302, such as the “LUMINANCE” selectable element 304, downwardly to another selectable element 302, such as the “INFORMATION” selectable element 322 highlighted in FIG. 3A. Conversely, the “UP” navigation button 334 enables navigation upwardly from one selectable element 302 to another selectable element 302.

FIG. 3A shows example information in example area 340 of the menu layer 300. In the example of FIG. 3A, the example information includes a current mode of the display (e.g., 1920×1200 60 HZ), an optional mode of the display (e.g., 1920×1200 60 HZ), a current input (e.g., HDMI 1), a color setting (e.g., sRGB (D65)), backlight hours (e.g., 345) measured by the example timer 260, serial number (e.g., CN430800001), and a firmware revision number (e.g., TNN100). The example area 340 may include any example information relating to the manufacturer, the display device 200, the display device 200 configuration and/or a state of the display device 200. In FIG. 3A, the “INFORMATION” selectable element 322 is selected, which activates a selectable element 345 for “VIEW RATING LABEL.”

FIG. 3B depicts an example of a first electronic rating label 350 bearing electronic rating label information 225. In response to a selection of the selectable element 345, the display controller 210 of FIG. 2 displays image data (e.g., a bitmap (bmp) image) for the first electronic rating label 350 having electronic rating label information 225 as an overlay to the menu layer 300 in a central portion of the display device 200. In some examples, the first electronic rating label 350 is image data stored in the memory 220 in a raster format, a vector format, or a combination format (e.g., metafile, etc.). In some examples, the first electronic rating label 350 includes a frame, a plurality of frame portions and/or a plurality of lines of the first electronic rating label 350 that may be assembled together and displayed by the display controller 210.

In the example of FIG. 3B, the electronic rating label information 225 includes an example display designator 351, an example regulatory model number field 352, an example manufacturer model number field 353, an example input rating field 354, an example product number code 355, an example serial number field 356, an example bar code 357 or quick response (QR) code or the like, an example manufacturing information field 358 (e.g., manufacturing location, manufacturing date, etc.), an example assembly part(s) number(s) field 359, an example first rating information 372 (e.g., an UL certification mark), an example second rating information 374 (e.g., a FCC declaration of conformity), an example third rating information 376 (e.g., a NOM mark) and an example Nth rating information 378 (e.g., an ENERGY STAR mark), where N is any integer.

FIG. 3C depicts an example second electronic rating label 380, including electronic rating label information 225 in a first section 382, a second section 384 and a third section 386, displayed in response to a selection of the selectable element 345. In FIG. 3C, instead of overlaying the second electronic rating label 380 over the menu layer 300, the display controller 210 of FIG. 2 displays image data for an electronic rating label having electronic rating label information 225 adjacent the selectable elements 302 of the menu layer 300.

As in FIG. 3B, the second electronic rating label 380 includes image data stored in the memory 220 in a raster format, a vector format, or a combination format (e.g., metafile, etc.). In some examples, the second electronic rating label 380 includes a frame, a plurality of frame portions and/or a plurality of lines of the second electronic rating label 380 that may be assembled together and displayed by the display controller 210. In the example of FIG. 3C, the electronic rating label information 225 includes the information noted above with respect to FIG. 3B in the first section 382 and the second section 384. Additionally, the second electronic rating label 380 includes an example code 390, such as a 1D bar code or a 2D bar code (e.g., a PDF417 code as illustrated, a QR code, etc.) in the third section. In the state represented in FIG. 3C, the display controller 210 displays the navigation interface 325 to include only the “ENTER” button 330 and the “BACK” button 336, which may be selected to navigate away from the second electronic rating label 380.

The code 390 includes embedded information from the second electronic rating label 380. For instance, in some examples, the code 390 includes the display designator 351, the regulatory model number field 352, the manufacturer model number field 353, the input rating field 354, the serial number field 355, the product number code 356, the manufacturing information field 358 (e.g., manufacturing location, manufacturing date, etc.), the assembly part(s) number(s) field 359, a current revision number 360 for a driver, first rating information 372, second rating information 374, third rating information 376 and/or Nth rating information 378. In some examples, the code 390 includes embedded information from a source external to the first electronic rating label 350 and/or the second electronic rating label 380. For instance, the code 390 may include a link to a website (e.g., a uniform resource locator (URL)) accessible to provide additional information and/or service. In another example, the code 390 may be dynamically or adaptively generated to include a number of hours of operation of the display from the timer 260, an input to the display device 200, a current revision number for a program or operating system installed on a computer operatively associated with the display device 200 and/or a display device 200 error code or codes indicating a state of the display device 200 and/or connection to the display device 200. In this latter example, the code 390 is generated by the display controller 210 prior to display of the electronic rating label information 225.

In some examples, the menu layer 300 may itself overlay a source video image (i.e., an active video/source image). However, a source video image is not required and the menu layer 300 and/or the electronic rating label information 225 may be displayed on the display screen 202 even if a video cable for the display 200 is not attached to a source.

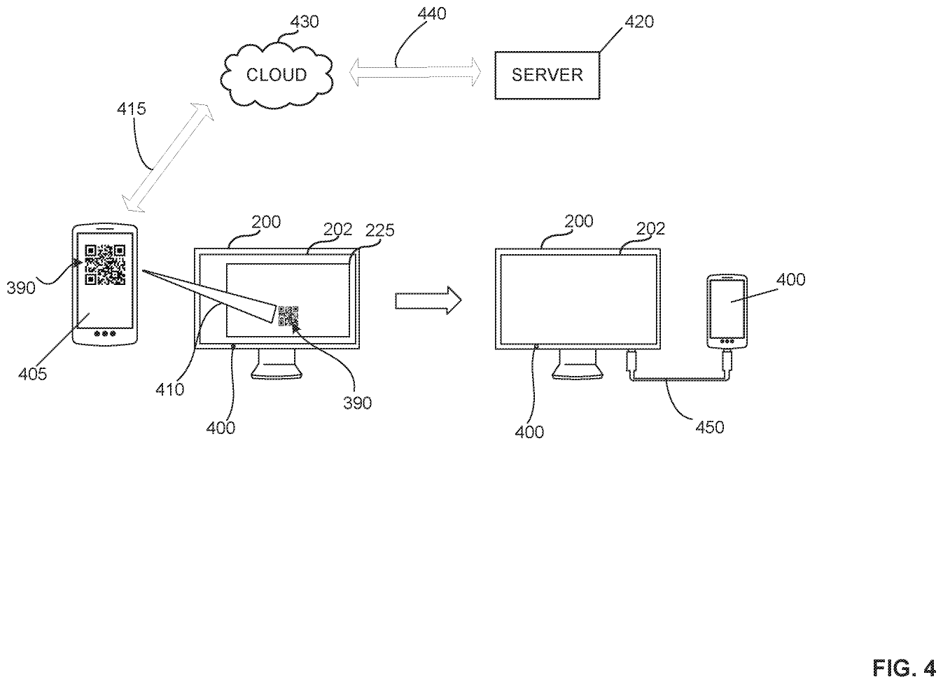

FIG. 4 depicts an example use case for example first electronic rating label 350 and/or the example second electronic rating label 380. In this example, rather than accessing the electronic rating label information 225 through the menu layer, as described in examples of FIGS. 3A-3B, the electronic rating label information 225 of the memory 220 is directly accessible via a pushbutton 400 on the display device 200. In some examples, the pushbutton 400 is dedicated solely to the display of the electronic rating label information 225. Accordingly, in some examples, the memory 220 of FIG. 2 may omit the menu layer information 226, with the display controller 210 being constructed to display the electronic rating label information 225 independent of (e.g., irrespective of a presence of or an absence of) a menu layer and/or a source video image. In such examples, the pushbutton 400 may be activated, such as via depression, and the electronic rating label information 225 displayed on the display screen 202 even if a video cable for the display 200 is not attached to a source. Again, in accordance with the teachings herein, inclusive of the examples of FIGS. 3A-3B, a video source signal is not required for the display of the electronic rating label information 225 on the display 200. In some examples, the pushbutton 400 may perform an additional function other than the display of the electronic rating label information 225. In this example, display of the electronic rating label information 225 does not require navigation through a menu layer.

In FIG. 4, regardless of a manner in which the electronic rating label information 225 and code 390 was caused to be displayed, an example external device 405 (e.g., a cellular phone, etc.) is used to scan the code 390, as represented by the scan pathway 410. In some examples, the example external device 405 (e.g., a cellular phone, etc.) is used to scan the code 390, which may include a device-specific URL code, such as a code specific to the display device 200. In some examples, the example external device 405 (e.g., a cellular phone, etc.) is used to scan a bar code, QR code or device-specific URL code of a physical label attached to the electronic device (e.g., a display device, a computer, a handheld electronic device, a printer, etc.).

The external device 405 is then communicatively coupled, via a first communication pathway 415, to an external server 420 or device connected to the cloud or the Internet 430 via a second communication pathway 440. The first communication pathway 415 and/or the second communication pathway 440 include a wireless and/or a hardwired connection. In some examples, the external server 420 is associated with a website of the manufacturer of the display device 200 (e.g., www.hp.com/support) or a website of a third-party service provider providing services for the display device 200 or other electronic device. In some examples, the external server 420 is associated with a customer service provider (e.g., a help desk, etc.) for the manufacturer of the display device 200 or other electronic device.

In some examples, the external server 420 analyzes the code 390 to determine the make and model of the display or other electronic device from the information in at least one field on the code 390 or bar code (e.g., the display designator field 351, the regulatory model number field 352, the manufacturer model number field 353, the serial number field, the product number code 356, the first rating information 372, the second rating information 374, the third rating information 376, the Nth rating information 378, etc.) and to determine any other relevant information pertinent to the accessing of the external server 420 by the external device 405 (e.g., number of hours of operation of the display from the timer 260, an input to the display device 200, a currently revision number for a driver, a current revision number for a program or operating system installed on a computer operatively associated with the display device 200, a display device 200 error code or codes indicating a state of the display device 200 and/or connection to the display device 200, etc.).

In some examples, the code 390 includes only the display device 200 serial number and the external server 420 uses the display device 200 serial number to look up the display device 200 data and populate the fields of an electronic rating label displayed on the external device 405 by the external server 420 via the first communication pathway 415 and the second communication pathway 440.

In some examples, the external server 420 provides a description for each logo associated with the code 390 and, by association, the display device 200. For instance, a user wanting to understand the certifications of the device (e.g., display device 200, etc.) associated with the code 390 (e.g., QR code) or bar code provided by the external device 405, the external server 420 may provide a description for each element of the first rating information 372 through the Nth rating information 378 (e.g., a description of the FCC declaration of conformity 162, the UL certification mark(s) 164, the NOM mark 166, the ENERGY STAR mark 168, the VDE mark, the GS-Mark, the “emc-Mark,” the European EMC Mark, the CSA mark, the D-Mark, the EMC Mark, the Fl Mark, the Fimko EMC certificate, the CE mark, the CCC Mark, or any other mark or certification associated with the display device 200 or other electronic device from which the code 390 (e.g., QR code) or bar code 357 was scanned by the external device 405.

In some examples, the external server 420 provides an option to translate the electronic rating label associated with the QR code or bar code (e.g., the electronic rating label corresponding to the code 390, etc.) from a first language (e.g., English, etc.) into a second language (e.g., Chinese, etc.). In another example, where a bar code or QR code is scanned from a physical label attached to an electronic device (e.g., a display device, a computer, a handheld electronic device, a printer, etc.), the external server 420 similarly provides an option to translate the electronic rating label associated with the QR code or bar code from a first language into a second language.

In some examples, the external server 420 provides options to the external device 405. In some examples, the external server 420 provides an option for the printing of the electronic rating label (e.g., the first electronic rating label 350, the second electronic rating label 380, etc.) via the external device 405, such as by a printer communicatively coupled to the external device 405 via a wireless or a hardwired connection. For instance, the external server 420 transmits to the external device 405 a printable file or image corresponding to the electronic rating label (e.g., the first electronic rating label 350, the second electronic rating label 380, etc.) and the external device 405 transmits the printable file or image to a printer. For instance, a user (e.g., a customer, a government agent (e.g., customs, etc.), etc.) can download a copy of the electronic rating label from the external server 420 and print it to an attached printer.

In some examples, responsive to the information conveyed to the external server 420 via the code 390, the external server 420 provides to the external device 405, via the first communication pathway 415 and the second communication pathway 440, software and/or firmware updates (i.e., machine readable instructions) for the display device 200. The software and/or firmware updates may include, for example, updated drivers or files for the external device 405 to transfer to the display device 200 associated with the code 390.

FIG. 4 also shows an example of a communicative coupling of the external device 405 to the display device 200 via an example hardwired connection 450 (e.g., a USB to USB connector, a FireWire connector, etc.). In some examples, the communicative coupling of the external device 405 to the display device 200 may include a wireless connection (e.g., a Bluetooth connection, etc.). The external device 405 is then to transfer to the display device 200, via the hardwired or wireless connection, the software and/or firmware updates.

FIG. 4 thus depicts an example use wherein a user needing to obtain updates to the display device 200 is able to scan the code 390 from the electronic label information displayed on the displayed electronic label 380 using the external device 405, download the update (e.g., a firmware (FW update) or desired documentation (e.g., a customer service advisory, an instruction manual, a repair manual, etc.) from the external server 420 (e.g., from the cloud, etc.), and then connect to the display device 200 to transfer the update to the display device 200.

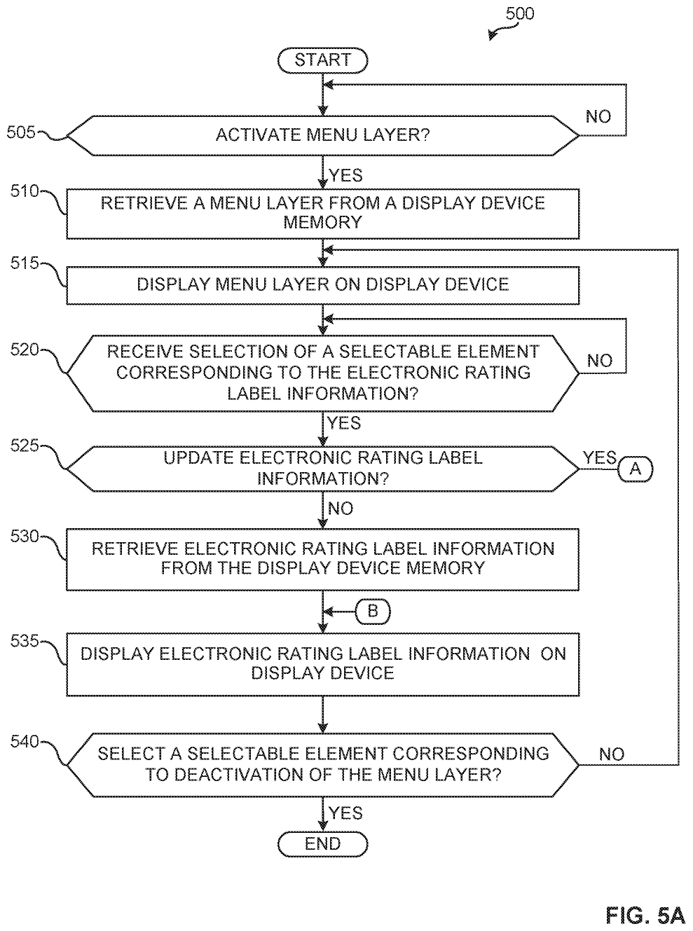

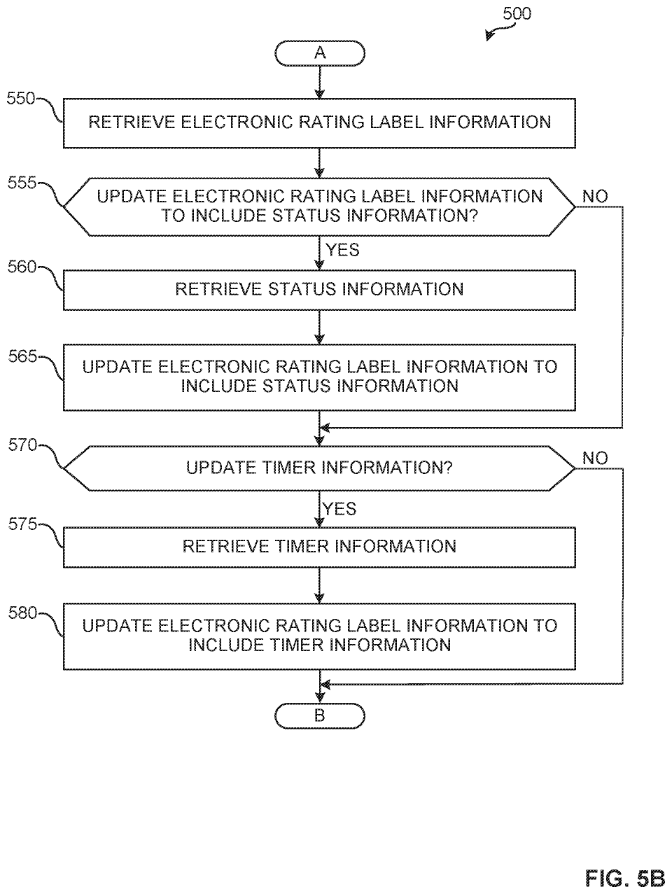

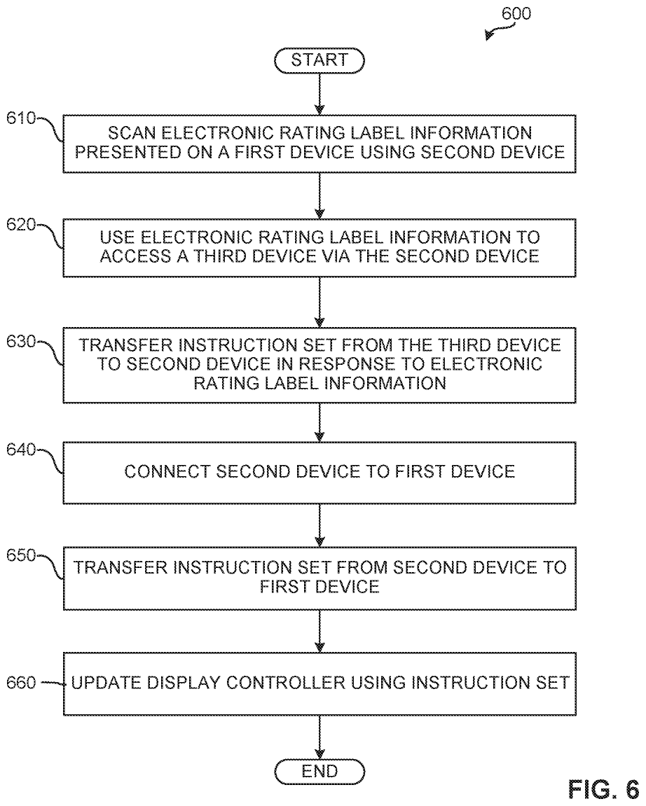

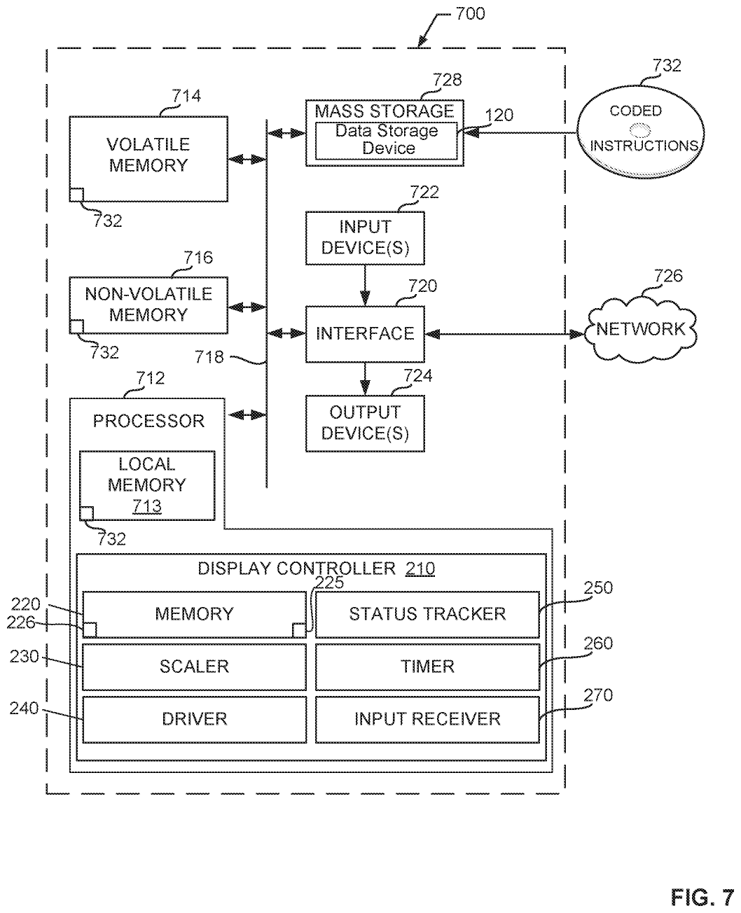

FIGS. 5A-5B are flowcharts representative of machine readable instructions that may be executed to implement the example display controller of FIG. 2. In these examples, the machine readable instructions comprise a program for execution by a processor such as the processor 712 shown in the example processor platform 700 discussed below in connection with FIG. 7. The programs may be embodied in software stored on a tangible computer readable storage medium such as a CD-ROM, a floppy disk, a hard drive, a digital versatile disk (DVD), a Blu-ray disk, or a memory associated with the processor 712, but the entire program and/or parts thereof could alternatively be executed by a device other than the processor 712 and/or embodied in firmware or dedicated hardware. Further, although example programs are described with reference to the flowchart illustrated in FIGS. 5A-5B or FIG. 6, discussed below, many other methods of implementing the example display controller 210 may alternatively be used. For example, the order of execution of the blocks may be changed, and/or some of the blocks described may be changed, eliminated, or combined.

As mentioned above, the example machine readable instructions of FIGS. 5A-5B or FIG. 6, discussed below, may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 5A-5B or FIG. 6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The example program 500 of FIG. 5A begins with the display controller 210 activating the menu layer at example block 505 following a determination by the display controller 210 that the menu layer is to be activated. For instance, the display controller 210 activates the menu layer at example block 505 in response to an input from the input device 204 or the external input device 205.

If the menu layer is to be activated by the display controller 210 at block 505 (result=“YES”), control passes to example block 510, where the display controller 210 retrieves the menu layer information 226 corresponding to the menu layer 300 from a display device memory 220. An example menu layer 300 is shown in FIG. 3A and FIG. 3C. The actual appearance of the menu layer 300 and the number of options available are determined in part by a complexity of the display controller 210 (e.g., a complexity of a display controller 210 chipset, etc.).

In some examples, the options available are related to a number of inputs supported by the display controller 210, an amount of onboard memory (e.g., a size of the memory 220, an internal OS for the display controller 210 and/or a number of external chipsets supported (e.g., audio, USB hubs, memory, etc.). The addition of more onboard memory to the display controller 210, for example, would allow for more graphics, colors and text/characters to appear at one time on a page or frame of the menu layer 300, would enable display of smoother text or fonts, and would enhance options to import BMP/PNG graphics for OSD icons or graphics images to for displaying in the OSD menus or on-screen messages.

At example block 515, the display controller 210 uses the menu layer information 226 to display the menu layer 300 on the display device 200. In some examples, the scaler 230 includes an OSD menu layer overlay function that overlays the OSD menu on the screen 202 of the display device 200 on top of a source video image. The OSD menu layer permits, for example, adjusting of display specific controls.

At example block 520, the display controller 210 determines if a selectable element 302 corresponding to the electronic rating label (e.g., the first electronic rating label 350, the second electronic rating label 380, etc.) or electronic rating label information 225 is selected. For instance, the display controller 210 determines at block 520 if the “INFORMATION” selectable element 322 is selected. If the result at block 520 is “NO,” control passes back to block 520. If the result at block 520 is “YES,” control passes to example block 525.

At block 525, the display controller 210 determines if it is to update the electronic rating label information 225. If the result at block 525 is “YES,” control passes to example block 550 of FIG. 5B. If the result at block 525 is “NO,” control passes to example block 530, where the display controller 210 retrieves electronic rating label information 225 from the display device memory 220. Control then passes to example block 535.

At block 535, the display controller 210 displays the electronic rating label information 225 on the display device 200 via the scaler 230 and the driver 240. Control then passes to example block 540.

At block 540, the display controller 210 is to determine, via the input receiver 270, if a selection has been made of a selectable element 302 corresponding to deactivation of the menu layer 300. For example, the input receiver 270 registers a selection of the selectable element 324 for “EXIT” via the navigation interface 325 and the touch screen 203 or via the input device 204. If the display controller 210 determines that the selectable element 324 for “EXIT” has been selected (result at block 540=“YES”), the example program 500 ends. If the display controller 210 determines that the selectable element 324 for “EXIT” has not been selected (result at block 540=“NO”), control passes to block 515.

As noted above, if a result at block 525 is “YES,” control passes to example block 550 of FIG. 5B where the display controller 210 retrieves electronic rating label information 225 from the memory 220. Control then passes to example block 555.

At block 555, the display controller 210 determines if the electronic rating label information 225 is to include status information. If the result at block 555 is “YES,” control passes to example block 560. If the result at block 555 is “NO,” control passes to example block 570.

At block 560, the display controller 210 retrieves the status information. At block 565, the display controller 210 updates the electronic rating label information 225 to include status information. For example, the display controller 210 updates the code 390 to include the status information (e.g., a state or condition of the display device 200, an error code or flag, etc.). Control then passes to example block 570.

At block 570, the display controller 210 determines if the timer information is to be updated. If the result at block 570 is “YES,” control passes to example block 575. If the result at block 570 is “NO,” control passes to example block 535.

At block 575, the display controller 210 retrieves the timer information from the timer 260. Control then passes to example block 580. At block 580, the display controller 210 updates the electronic rating label information 225 to include the timer information. For example, the display controller 210 updates the code 390 to include the timer information (e.g., a cumulative number of minutes or hours of operation of the display device 200, etc.). Control then passes to example block 535.

FIG. 6 is a flowchart representative of a method 600 that may be implemented to update the example display controller 210 of FIG. 2. The method 600 starts at block 610 with the scanning of the electronic rating label information 225 from a first device (e.g., display device 200, etc.) using a second device (e.g., external device 405 (e.g., a cellular phone, etc.)). In some examples, block 610 includes scanning of a rating label information from a physical rating label on a first device (e.g., display device 200, a printer, a cellular device, etc.) using a second device (e.g., external device 405 (e.g., a cellular phone, etc.)).

At block 620, the electronic rating label information 225 is used to access a third device (e.g., an external server 420, etc.) via the second device (e.g., external device 405 (e.g., a cellular phone, etc.)). For instance, the scanned electronic rating label information 225 may include a URL to access the third device. In some examples, a URL for the third device is entered into the second device independent of the electronic rating label information 225.

At block 630, following access of the third device (e.g., external server 420) by the second device (e.g., external device 405), the third device transfers an instruction set (e.g., software, firmware, etc.) to the second device in response to the electronic rating label information 225. For example, the electronic rating label information 225 includes a model number, serial number or revision number for firmware (e.g., revision no. 2.1) resident on the display device 200. The third device, in view of the electronic rating label information 225 provided by the second device, determines in this example that the firmware (e.g., revision no. 2.3) of the first device is outdated and the third device transfers a current version of the firmware to the second device.

At block 640, the second device (e.g., external device 405) is connected to the first device (e.g., display device 200) via a hardwired connection 450 or a wireless connection.

At block 650, once connection has been established between the second device (e.g., external device 405) and the first device (e.g., display device 200), the instruction set received from the third device is transferred from the second device to the first device and, at block 660, the display controller 210 is updated with the instruction set from the second device.

FIG. 7 is a block diagram of an example processor platform 700 capable of executing the instructions of FIGS. 5A-5B and/or FIG. 6 to implement the display controller 210 of FIG. 2. The processor platform 700 can be, for example, a server, a personal computer, a mobile device (e.g., a cell phone, a smart phone, a tablet such as an iPad™), a personal digital assistant (PDA), an Internet appliance or any other type of computing device. In some examples, the process platform 700 is a display device.

The processor platform 700 of the illustrated example includes a processor 712. The processor 712 of the illustrated example is hardware. For example, the processor 712 can be implemented by integrated circuits, logic circuits, microprocessors and/or controllers from any desired family or manufacturer. In the illustrated example, the processor 712 implements the example display controller 210, which includes the example memory 220 including the example electronic rating label information 225, the example scaler 230, the example driver 240, the example status tracker 250, the example timer 260 and/or the example input receiver 270.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), and/or a PCI express interface.

In the illustrated example, an input device(s) 722 is connected to the interface circuit 720. The input device(s) 722 permit(s) a user to enter data and commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

An output device(s) 724 is also connected to the interface circuit 720 of the illustrated example. The output devices 724 can be implemented, for example, by a display device and, more particularly, by an emission component of a display device. In some examples, the display device may include a light emitting diode (LED) display device, an organic light emitting diode (OLED) display device, a liquid crystal display (LCD) device, or a cathode ray tube (CRT) display device. In some examples, the interface circuit 720 of the illustrated example includes, for example, a graphics driver card, a graphics driver chip and/or a graphics driver processor. In some examples, the interface circuit 720 of the illustrated example does not include a graphics driver card, a graphics driver chip and/or a graphics driver processor.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.).

The processor platform 700 of the illustrated example also includes a mass storage device(s) 728 for storing software and/or data. Examples of such mass storage devices 728 include floppy disk drives, hard drive disks, compact disk drives, Blu-ray disk drives, RAID systems, and digital versatile disk (DVD) drives. In the illustrated example, the mass storage device(s) 728 implements the data storage device 120.

The coded instructions 732 of FIGS. 5A-5B and 6 may be stored in the mass storage device 728, in the volatile memory 714, in the non-volatile memory 716, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A display, comprising:
a memory including electronic rating label information; and
a scaler to display the electronic rating label information from the memory on the display.

2. The display of claim 1, further including a pushbutton to cause the scaler to display the electronic rating label information over the source video image.

3. The display of claim 1, the memory further including menu layer information for a menu layer, the menu layer including a first option to display the electronic rating label information and a second option to display an adjustment interface.

4. The display of claim 1, the memory including a plurality of frame portions of the electronic rating label information.

5. The display of claim 4, the frame portions of the electronic rating label including lines of the electronic rating label information or pixels of the electronic rating label information.

6. The display of claim 1, the memory including a frame of an electronic rating label information.

7. The display of claim 1, the electronic rating label information including at least one of a display model number, a display product number, a display part number, a display serial number, a display manufacturing date, an input rating number, a certification marking or a code including at least one of a bar code, a quick response code or a uniform resource locator.

8. The display of claim 7, the code including embedded information including at least one of a number of hours of operation of the display, inputs to the display and display error codes.

9. The display of claim 8, further including a display controller, wherein the code is generated by the display controller prior to display of the electronic rating label information.

10. A tangible computer readable storage medium comprising instructions that, when executed, cause a display device to at least:
retrieve a menu layer from a display device memory in response to activation of an input device on the display device;
retrieve electronic rating label information from the display device memory in response to selection of a selectable element corresponding to the electronic rating label information from the menu layer displayed on the display device; and
display the electronic rating label information on the display device.

11. The tangible computer readable storage medium of claim 10, further including instructions, when executed, to cause the display device to display the electronic rating label information as a frame, the display device memory including the frame of the electronic rating label information.

12. The tangible computer readable storage medium of claim 10, further including instructions, when executed, to cause the display device to display the electronic rating label information as a plurality of frame portions.

13. The tangible computer readable storage medium of claim 10, further including instructions, when executed, to cause the display device to integrate in the electronic rating label information a number of hours of operation of the display, inputs to the display, a display error code or a uniform resource locator.

14. A tangible computer readable storage medium comprising instructions that, when executed, cause a first machine to at least:
receive, from a second machine, a code including electronic rating label information relating to a first display device of a third machine;
analyze the code and the electronic rating label information to determine if an instruction set of the third machine is out of date; and
output to the second machine an updated instruction set for transfer to the third machine or display on a second display device of the second machine an option relating to the first display device.

15. The tangible computer readable storage medium of claim 14, wherein the option includes displaying, via the second display device, a description for a logo associated with the electronic rating label information, a translation of the electronic rating label information in a selected language.
